(19) United States
(12) Patent Application Publication
(10) Pub. No.: US 2016/0037761 A1
(43) Pub. Date: Feb. 11, 2016

(54) Tripod mount for a fishing pole

(71) Applicant: Harold Hollingshead, Chillicothe, OH (US)

(72) Inventor: Harold Hollingshead, Chillicothe, OH (US)

(21) Appl. No.: 14/683,239

(22) Filed: Apr. 10, 2015

Related U.S. Application Data
(60) Provisional application No. 61/977,118, filed on Apr. 9, 2014.

(51) Int. Cl. A01K 97/10; F16M 11/00

(52) U.S. Cl. CPC A01K 97/10; F16M 11/00

(57) ABSTRACT

A tripod mount for a fishing pole provide an open end and a closed end, and are secured together with a fastening element near their open ends. The user fills the pipes with water by dipping them into a creek or pond, using the water as ballast. The user then spreads the pipes into a tripod form and adjusts the height of the pipes accordingly. The pipes form a fork at their open ends, wherein a fishing rod may be rested.

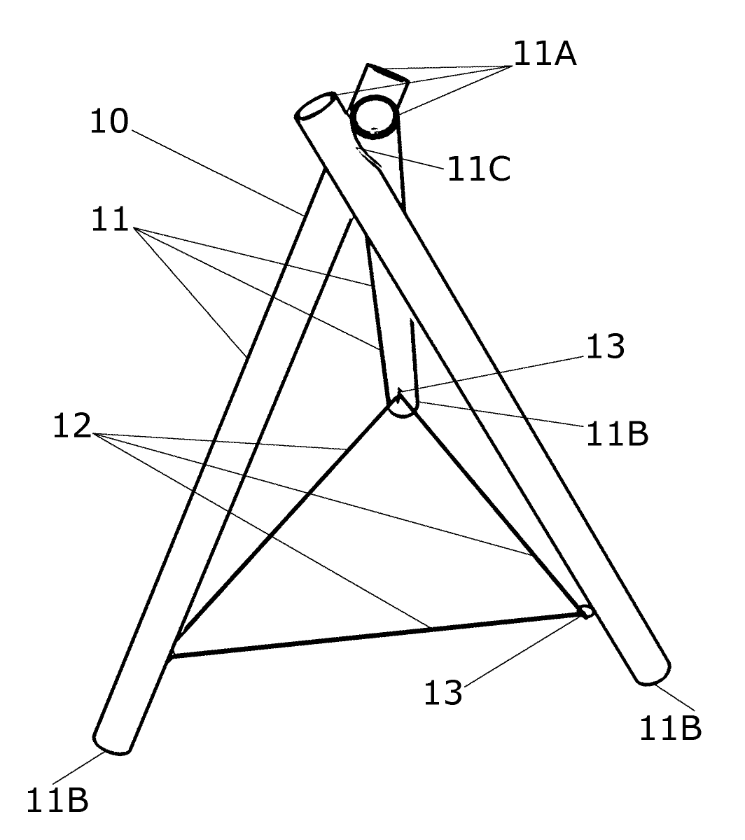

### CROSS-REFERENCE TO RELATED APPLICATIONS

This application claims the benefit of U.S. Provisional Application No. 61/977,7118, filed Apr. 9, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to sport fishing equipment and accessories, and in particular to a tripod mount for a fishing pole. Sport fishermen are aware that to successfully catch a fish, the fisherman must sometimes leave the fishing line in the water for an extended period of time and wait for the fish to bite. The fisherman may not wish to wait, and may instead choose to become involved in other activities nearby. A way to hold the fishing pole in an upright position is desired. A tripod mount for a fishing pole, which is lightweight, inexpensive, and reliable, would resolve this problem.

### SUMMARY OF THE INVENTION

Accordingly, the invention is directed to a tripod mount for a fishing pole. The mount comprises pipes which provide an open end and a closed end, and are secured together with a fastening element near their open ends. The user fills the pipes with water by dipping them into a creek or pond, using the water as ballast. The user then spreads the pipes into a tripod form and adjusts the height of the pipes accordingly. The pipes form a fork at their open ends, wherein a fishing rod may be rested.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE is a front perspective view of the first exemplary embodiment, displaying the mount 10, the pipes 11, the open ends 11A, the closed ends 11B, the attachment point 11C, the lanyard 12, and the eye screws 13.

### DETAILED DESCRIPTION OF THE INVENTION

Referring now to the invention in more detail, the invention is directed to a tripod mount 10 for a fishing pole. The mount 10 comprises pipes 11 which provide an open end 11A and a closed end 11B, and are secured together with a fastening element at an attachment point 11C, which is relatively near their open ends 11A (as shown) such that they are rotatably affixed relative to one another in a manner that permits shifting between a tripod configuration (wherein each pipe 11 has an angle of about 60° relative to each other pipe 11) and a storage configuration (wherein each pipe is substantially parallel to the others). The user fills the pipes 11 with water by dipping them into a creek or pond, using the water as ballast. The user then spreads the pipes 11 into a tripod form and adjusts the height of the pipes 11 accordingly. The pipes 11 form a fork at their open ends, wherein a fishing rod may be rested.

It is to be understood that while the invention is intended for use with a fishing pole, this is not intended as a limitation. The invention may be used with any object which is narrow enough to rest between the open ends 11A and needs support. The available crevasse, however, is best understood as relatively small relative to the length of the pipes 11; this is due to the attachment point 11C being relatively near the open ends 11A. The materials and components used in manufacture are preferably selected off the shelf, to limit manufacturing costs and the eventual retail price.

The first exemplary embodiment provides three pipes 11, each of which provides an open end 11A at the top, and a closed end 11B at the bottom. The open ends 11A may be secured together flexibly and rotatably at the attachment point 11C with a short length of cord or light chain. The cord or light chain may be affixed to each pipe 11 by passing through an eye screw which is permanently affixed to the pipe 11, preferably two inches below the open end 11A. The closed ends are similarly secured together at a greater distance by a second, greater length of cord or light chain, serving as a lanyard 12, which passes through an eye screw 13 four to five inches above the closed end 11B or, more generically, relatively near the closed end 11B. The length of the lanyard 12 is adjustable, for example, my tying it in a loop of variable diameter, to alter the spread of the pipes 11 and height of the mount 10.

The pipes 11 are preferably 24 inches in length, with an inside diameter of one-half inch. A larger version, which may be used with surf fishing poles, provides pipes 11 which are preferably 32 to 36 inches in length, with an inside diameter of three-quarters of an inch.

To use the first exemplary embodiment, the user may dip the mount 10 into a body of water to fill the pipes 11 with water. The user may then spread the closed ends 11B apart to create a tripod. Generically, the user may rotate the pipes 11 about the attachment point 11C such that the pipes 11 form a tripod. The user adjusts the length of the lanyard 13, as desired, for example by tying the lanyard 12 in a loop of the desired diameter. The user then rests the fishing rod or other item between the open ends 11A.

The pipes 11 are preferably manufactured from a rigid, durable material which is corrosion resistant, such as polyvinyl chloride or aluminum alloy. The lanyard 12 is preferably manufactured from a flexible, durable material, such as nylon, or a light chain which is preferably manufactured from a rigid, durable material of substantial tensile strength, such as steel or aluminum alloy. The eye screws 13 are preferably manufactured from a rigid, durable material which is corrosion resistant, such as aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A tripod mount comprising:
(a) three pipes;
(b) each of said three pipes having an open end and a closed end;
(c) said three pipes being rotatably affixed to one another at an attachment point;
(d) each of said three pipes having affixed thereto an eyehook;
(e) said eyehook being affixed near said closed end of each of said three pipes;
(f) a lanyard; and
(g) said lanyard being passed through said eyehook on each of said three pipes and being tied in a loop.

2. The tripod mount of claim 1 wherein said attachment point is relatively near to said open end of each of said three pipes.

3. A tripod mount and a method of use therefore, the tripod mount comprising:
(a) three pipes;
(b) each of said three pipes having an open end and a closed end;
(c) said three pipes being rotatably affixed to one another at an attachment point;
(d) each of said three pipes having affixed thereto an eyehook;
(e) said eyehook being affixed near said closed end of each of said three pipes;
(f) a lanyard; and
(g) said lanyard being passed through said eyehook on each of said three pipes and being tied in a loop;
and the method comprising:
(h) filling said three pipes with water;
(i) rotating said three pipes relative to one another such that said three pipes form a tripod configuration;
(j) tying said lanyard into a loop at a desired diameter; and
(k) resting an item on said attachment point between said open end of each of said three pipes.

4. The tripod mount and a method of use therefore of claim 3 wherein said attachment point is relatively near to said open end of each of said three pipes.

5. The tripod mount and method of use therefore of claim 3 wherein said item is a fishing rod.

6. The tripod mount and method of use therefore of claim 4 wherein said item is a fishing rod.
